(19) United States
(12) Patent Application Publication
(10) Pub. No.: US 2025/0373602 A1
(43) Pub. Date: Dec. 4, 2025

(54) OUT-OF-BAND OTP EXCHANGE ACCESS CONTROL

(71) Applicant: ASSA ABLOY AB, Stockholm (SE)

(72) Inventor: Andréas Hallberg, Sölvesborg (SE)

(21) Appl. No.: 18/874,429

(22) PCT Filed: Jul. 12, 2022
(86) PCT No.: PCT/EP2022/069449

§ 371 Date: Dec. 12, 2024

(51) Int. Cl. H04L 9/40

(52) U.S. Cl. CPC H04L 63/0838

(57) ABSTRACT

Methods and systems are provided for performing operations comprising: establishing a secure channel between an authenticator device and a client device; generating, by the authenticator device, a one-time passcode (OTP) based on a token received from the client device; storing the OTP in a memory of the authenticator device; transmitting the OTP to the client device over the secure channel; receiving the OTP from the client device over an unsecure channel; and enabling access to a secure resource in response to determining that the OTP received from the client device matches the OTP stored in the memory of the authenticator device.

### BACKGROUND

Electronic credentials are increasingly being hosted in smart devices (e.g., smart phones, smart watches, and various other Internet-connected devices) and have become commonplace. Such electronic credentials are used to unlock electronic smart door locks (used, e.g., in hotels, enterprises), present digital identifiers of users (e.g., digital driver's licenses), and to present electronic tickets for entering ticketed events (e.g., concerts, sporting events, and so forth).

### SUMMARY

In some aspects, a method is provided comprising: establishing a secure channel between an authenticator device and a client device; generating, by the authenticator device, a one-time passcode (OTP) based on a token received from the client device; storing the OTP in a memory of the authenticator device; transmitting the OTP to the client device over the secure channel; receiving the OTP from the client device over an unsecure channel; and enabling access to a secure resource in response to determining that the OTP received from the client device matches the OTP stored in the memory of the authenticator device.

In some examples, the method includes: verifying that the token received from the client device is valid, wherein the OTP is generated in response to determining that the token is valid.

In some examples, the method includes: determining, by the authenticator device, whether one or more valid OTPs are stored in the memory; and in response to determining that one or more valid OTPs are stored in the memory of the authenticator device, initiating scanning an unsecure channel for an OTP message.

In some examples, the OTP received from the client device is included in the OTP message.

In some examples, the secure channel comprises a secure short-range communications channel, and wherein the unsecure channel comprises a public short-range communications channel.

In some examples, the secure channel comprises a first protocol, and wherein the unsecure channel comprises a second protocol.

In some examples, the secure channel is established automatically in response to detecting a signal from the client device and verification of one or more access conditions.

In some examples, the OTP is transmitted by the client device over the unsecure channel in response to receiving a user request by the client device to access the secure resource, the method includes: transmitting a message to client device indicating that the access to the secure resource has been enabled.

In some examples, the method includes: associating an expiration time with the OTP that is stored in the memory; and invalidating or removing the OTP after the expiration time.

In some examples, the OTP is received from the client device after the expiration time, the method includes: preventing access to the secure resource; and transmitting a message to client device indicating that the access to the secure resource has been prevented.

In some examples, the method includes: receiving, by the authenticator device, an idle token from the client device; and in response to receiving the idle token, extending the expiration time associated with the OTP.

In some examples, the idle token is received over the unsecure channel.

In some examples, the method includes: invalidating the OTP after receiving the OTP from the client device over the unsecure channel, wherein access to the secure resource is prevented in response to receiving an invalid OTP.

In some examples, the method includes: after invaliding the OTP, receiving the OTP from the same or another client device; determining that the OTP has been invalidated; and preventing access to the secure resource in response to determining that the OTP has been invalidated.

In some examples, the authenticator device comprises a server, wherein the server transmits an instruction to a physical access control device to enable access to the secure resource.

In some examples, the authenticator device comprises a physical access control device to enable access to the secure resource.

In some examples, the OTP is generated prior to the client device receiving a request to access the secure resource.

In some examples, a system including one or more processors; and computer-readable medium including instructions executed by one or more processes are provided to perform operations of any of the above methods.

### BRIEF DESCRIPTION OF THE DRAWINGS

FIG. 1 is a block diagram of an example authentication system, according to some embodiments.

FIG. 2 is a block diagram of an example authentication device, according to some embodiments.

FIG. 3 is an example output of the authentication system, according to some embodiments.

FIG. 4 illustrates example operations of the authentication system, according to some embodiments.

FIG. 5 illustrates example operations of the authentication system, according to some embodiments.

FIG. 6 is a block diagram illustrating an example software architecture, which may be used in conjunction with various hardware architectures herein described.

FIG. 7 is a block diagram illustrating components of a machine, according to some example embodiments.

### DETAILED DESCRIPTION

Example methods and systems for an authentication system are described. In the following description, for purposes of explanation, numerous specific details are set forth in order to provide a thorough understanding of example embodiments. It will be evident, however, to one of ordinary skill in the art that embodiments of the disclosure may be practiced without these specific details.

Typical secure access systems enable access to secure or protected resources by exchanging a set of credentials over an unsecure channel, such as a Bluetooth Low Energy (BLE) channel. This process is usually initiated when a user request is received by a client device to access a selected resource. At this point, a secure channel is established and used to perform all of the operations needed to provide access to the selected resource. The operations for setting up the BLE channel, exchanging credentials, and authenticating the credentials to provide access can take some time to perform which introduces delays. In some cases, the user can experience a delay on the order of several seconds, which can be very frustrating. Also, if the secure channel is compromised, the user's credentials can be stolen or copied by another device and used to access the same resource at a later time. Some systems attempt to increase the speed at which access is granted by upgrading software and hardware resources. This can lead to increased expenses and still only reduces the delays the users experience by insignificant amounts.

The disclosed embodiments provide an intelligent solution that addresses the above technical problems and challenges. Particularly, the disclosed technical solution detects nearby secure resources and/or client devices, such as by examining messages transmitted by such secure resources over an unsecured BLE channel. For example, a client device can approach a BLE radio field to a particular secure resource. In response, the client device can automatically (prior to receiving a user request to access the secure resource) establish a secure channel with the particular resource, such as by communicating with an authentication device associated with the secure resource. Once that secure channel is established, a token including credentials of the user is transmitted by the client device and is used by the authentication device to determine access privileges for the user. If the authentication device determines that the token allows the user to access the secure resource, the authentication device generates a one-time passcode (OTP) and stores the OTP locally in a storage device of the authentication device. Also, the authentication device transmits the OTP to the client device. At a later point, a user of the client device can request to access the secure resource and, in response, the previously generated and received OTP is retrieved and sent over an unsecure (public) BLE channel or network to the authentication device. The authentication device can determine the validity of the OTP and can grant/deny access in response to receiving the OTP over the public channel or network.

In this way, the disclosed techniques substantially reduce the amount of information exchanged over a network and operations performed to grant/deny access to a secure resource when a user request to access the secure resource is received. This expedites the process of granting access to a secure or protected resource and increases the overall efficiency of operating the device. Also, because the only information exchanged over the public network is an OTP, there is minimal risk of compromising a user's credentials. Because the OTP can only be used one time before being invalidated, if the OTP is copied by a second user or device, the second user or device will not be granted access to the secure or protected resource. As such, the disclosed techniques provide a low-cost solution to expediting operations performed in granting/denying a user access to a secure or protected resource.

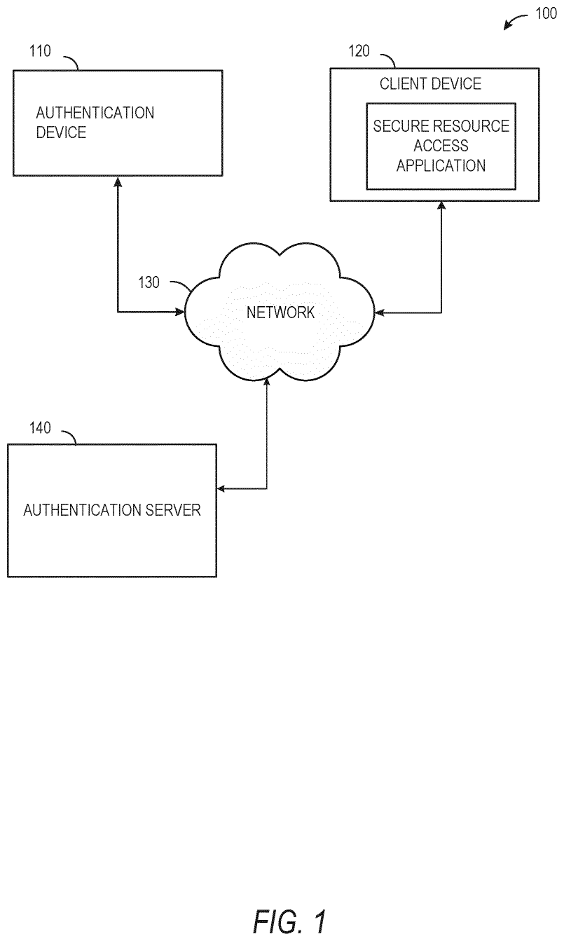

FIG. 1 is a block diagram showing an example authentication system 100, according to various example embodiments. The authentication system 100 can include a client device 120, an authentication device 110 that can store one or more OTPs and be used to control access to a protected asset or resource, such as through a lockable door, and an authentication server 140 that are communicatively coupled over a network 130 (e.g., Internet, BLE, ultra-wideband (UWB) communication protocol, Near Field Communication (NFC), and/or telephony network).

The client device 120 and the authentication device 110 and/or the authentication server 140 can be communicatively coupled via electronic messages (e.g., packets exchanged over the Internet, BLE, UWB, NFC, WiFi direct or any other protocol). While FIG. 1 illustrates a single authentication device 110 and a single client device 120, it is understood that a plurality of authentication devices 110 and a plurality of client devices 120 can be included in the authentication system 100 in other embodiments.

The authentication device 110 can include any one or a combination of an IoT device, a database, a website, a server hosting a website at a URL address, a physical access control device, logical access control device, governmental entity device, ticketing event device, and residential smart lock and/or other Bluetooth or NFC or UWB based smart device. In some examples, the authentication device 110 can be part of the client device 120. In some examples, the authentication device 110 is external to the client device 120 and communicates with the client device 120 over a network 130.

The authentication device 110 can protect a secure area, asset or resource and can be configured to receive a token that includes a digital credential or digital credentials from the client device 120. The authentication device 110 can verify that the received digital token is authorized to access the secure area, such as by communicating with the authentication server 140. In response, the authentication device 110 can grant access to the secure area or protected resource. The authentication device 110 itself or by communication with the authentication server 140 can verify whether the digital token is authorized to access the identified secure resource. If so, the authentication device 110 can grant access to the client device 120 (e.g., by unlocking an electronic door lock) or individual associated with the client device 120.

In some cases, the authentication device 110 grants access to the secure area or protected resource in response to receiving a valid OTP from the client device 120. In such circumstances, the authentication device 110 monitors traffic on a public network (unsecure network), such as a public BLE channel, for messages that include one or more OTPs. In response to detecting a message on the public network, the authentication device 110 extracts the OTP from the message and searches a local database or a database stored on the authentication server 140 for previously generated and stored OTP. In response to determining that the received OTP matches or corresponds to one of the OTPs in the database, the authentication device 110 determines whether the previously stored OTP is valid (e.g., by determining whether the expiration time of the OTP has elapsed and/or whether the OTP has previously been used). If the OTP is valid, the authentication device 110 grants access to the secure resource and concurrently, before or after granting access, invalidates the OTP that is stored in the database to prevent the OTP from being used again to access the secure resource.

In some cases, some or all of the components and functionality of the authentication device 110 can be included as part of the authentication server 140. In some cases, the authentication device 110 is part of the secure resource (e.g., door lock) or secure asset or protected area. In some cases, the authentication device 110 is configured to communicate via a secure channel or private link with the secure resource (e.g., door lock) or secure asset or protected area to provide instructions to grant access, such as to open the lock. A client device 120 may be, but is not limited to, a mobile phone, desktop computer, laptop, portable digital assistant (PDA), smart phone, a wearable device (e.g., a smart watch), tablet, Ultrabook, netbook, laptop, multi-processor system, microprocessor-based or programmable consumer electronics, or any other communication device that a user may use to access the network 130.

For example, the authentication device 110 (and/or the client device 120) can include or be associated with a physical access control device that can include or be associated with an access reader device connected to a physical resource (e.g., a door locking mechanism or backend server) that controls the physical resource (e.g., door locking mechanism). The physical resource associated with the physical access control device can include a door lock, an ignition system for a vehicle, or any other device that grants or denies access to a secure resource or component, such as a physical component and that can be operated to grant or deny access to the secure resource or component. For example, in the case of a door lock, the physical access control device can deny access, in which case the door lock remains locked and the door cannot be opened, or can grant access, in which case the door lock becomes unlocked to allow the door to be opened. As another example, in the case of an ignition system, the physical access control device can deny access, in which case the vehicle ignition system remains disabled and the vehicle cannot be started, or can grant access, in which case the vehicle ignition becomes enabled to allow the vehicle to be started.

Physical access control covers a range of systems and methods to govern access, for example by people, to secure areas or secure assets. Physical access control includes identification of authorized users or devices (e.g., vehicles, drones, etc.) and actuation of a gate, door, or other facility used to secure an area or actuation of a control mechanism, e.g., a physical or electronic/software control mechanism, permitting access to a secure asset. The physical access control device forms part of a physical access control system (PACS), which can include a reader (e.g., an online or offline reader) that holds authorization data and can be capable of determining whether credentials (e.g., from credential or key devices such as radio frequency identification (RFID) chips in cards, fobs, or personal electronic devices such as mobile phones) are authorized for an actuator or control mechanism (e.g., door lock, door opener, software control mechanism, turning off an alarm, etc.), or PACS can include a host server to which readers and actuators are connected (e.g., via a controller) in a centrally managed configuration. In centrally managed configurations, readers can obtain credentials from credential or key devices and pass those credentials to the PACS host server. The host server then determines whether the credentials authorize access to the secure area or secure asset and commands the actuator or other control mechanism accordingly.

In general, the authentication device 110 can include one or more of a memory, a processor, one or more antennas, a communication module, a network interface device, a user interface, and a power source or supply. The memory of the authentication device 110 can be used in connection with the execution of application programming or instructions by the processor of the authentication device 110, and for the temporary or long-term storage of program instructions or instruction sets, one or more OTPs, and/or credential, token or authorization data, such as credential data, credential authorization data, or access control data or instructions. For example, the memory can contain executable instructions that are used by the processor to run other components of authentication device 110 and/or to make access determinations based on credential or authorization data.

The memory of the authentication device 110 can comprise a computer readable medium that can be any medium that can contain, store, communicate, or transport data, program code, or instructions for use by or in connection with authentication device 110. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device.

The processor of the authentication device 110 can correspond to one or more computer processing devices or resources. For instance, the processor can be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor can be provided as a microprocessor, Central Processing Unit (CPU), or plurality of microprocessors or CPUs that are configured to execute instructions sets stored in an internal memory and/or memory of the authentication device 110.

The antenna of the authentication device 110 can correspond to one or multiple antennas and can be configured to provide for secure and/or unsecure wireless communications between authentication device 110 and a credential or key device (e.g., client device 120). The antenna can be arranged to operate using one or more wireless communication protocols and operating frequencies including, but not limited to, the IEEE 802.15.1, Bluetooth, Bluetooth Low Energy (BLE), NFC, ZigBee, GSM, CDMA, Wi-Fi, RF, UWB, and the like. By way of example, the antenna(s) can be RF antenna(s), and as such, may transmit/receive RF signals through free-space to be received/transferred by a credential or key device having an RF transceiver. In some cases, at least one antenna is an antenna designed or configured for transmitting and/or receiving UWB signals (referred to herein for simplicity as a “UWB antenna”) such that the reader can communicate using UWB techniques with the client device 120.

A communication module of the authentication device 110 can be configured to communicate according to any suitable communications protocol with one or more different systems or devices either remote or local to authentication device 110, such as one or more client devices 120. In some cases, the communication module communicates over a secure channel (e.g., secure BLE or NFC channel) with a client device 120 in which case all of the exchanged data is encrypted (e.g., end-to-end). In some cases, the communication module communicates over an unsecure channel (e.g., unsecure, public or open BLE or NFC channel) with a client device 120 in which case all or a portion of the exchanged data is unencrypted.

The network interface device of the authentication device 110 includes hardware to facilitate communications with other devices, such as a one or more client devices 120, over a communication network, such as network 130, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device can include an Ethernet port or other physical jack, a Wi-Fi card, a Network Interface Card (NIC), a cellular interface (e.g., antenna, filters, and associated circuitry), or the like. In some examples, a network interface device can include a plurality of antennas to wirelessly communicate using at least one of single-input multiple-output (SIMO), multiple-input multiple-output (MIMO), or multiple-input single-output (MISO) techniques.

A user interface of the authentication device 110 can include one or more input devices and/or display devices. Examples of suitable user input devices that can be included in the user interface include, without limitation, one or more buttons, a keyboard, a mouse, a touch-sensitive surface, a stylus, a camera, a microphone, etc. Examples of suitable user output devices that can be included in the user interface include, without limitation, one or more LEDs, an LCD panel, a display screen, a touchscreen, one or more lights, a speaker, and so forth. It should be appreciated that the user interface can also include a combined user input and user output device, such as a touch-sensitive display or the like.

The network 130 may include, or operate in conjunction with, an ad hoc network, an intranet, an extranet, a virtual private network (VPN), a LAN, a wireless network, a wireless LAN (WLAN), a wide area network (WAN), a wireless WAN (WWAN), a metropolitan area network (MAN), BLE, UWB, the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other short range or long range protocols, or other data transfer technology.

In some embodiments, the client device 120 implements a secure resource access application. The secure resource access application may run on the client device 120 and can be accessed by a user of the client device 120. The secure resource access application can allow an operator or user to access a resource or asset protected by the authentication device 110. The secure resource access application can automatically detect nearby authentication devices 110 (e.g., one or more protected or secure resources that are within a communication range of a BLE communication device of the secure resource access application). For example, the secure resource access application can continuously scan a public BLE channel for announcement messages transmitted by one or more authentication devices 110. In some examples, the authentication device 110 continuously scans a public BLE channel for announcement messages transmitted by client devices 120. In response to detecting an announcement message, the authentication device 110 initiates or establishes a secure channel with the client device 120 from which the announcement message was received. In some cases, the authentication device 110 controls access to multiple secure or protected resources. In some cases, each secure or protected resource is associated with a single instance of the authentication device 110.

In response to detecting a message transmitted by a particular authentication device 110, the secure resource access application initiates or establishes a secure channel (e.g., encrypted BLE channel) with the authentication device 110 or with the authentication server 140 associated with a nearby protected or secure resource or PACS. This can be performed automatically without receiving a user request by the secure resource access application to access the secure resource. Once the secure channel is established, the secure resource access application transmits a token that includes credentials of the user to the authentication device 110. In some cases, the secure resource access application obtains an identifier of the secure resource and determines whether the secure resource access application includes a token associated with the identifier. The secure resource access application only transmits the token and/or establishes the secure channel if the secure resource access application includes a token associated with the identifier.

The authentication device 110 verifies whether the credentials included in the token are authenticated and valid for accessing the protected resource or PACS. If so, the authentication device 110 generates an OTP and stores the OTP in a memory. The authentication device 110 transmits the OTP to the secure resource access application over the secure channel. The authentication device 110 then closes the secure channel and terminates the connection with the client device 120. In some examples, the secure resource access application terminates the secure channel.

The authentication device 110 accesses a list of OTPs stored in the memory to determine whether any OTP in the memory is valid. In some examples, the authentication device 110 associates a validity period or expiration time with some or all of the OTPs that are in the list. Once the expiration time or validity period elapses or is reached, the authentication device 110 automatically invalidates the corresponding OTP and/or deletes the OTP from the list stored in the memory.

In response to determining that at least one OTP in the memory is valid, the authentication device 110 monitors traffic on a public network (e.g., unsecure BLE network) to detect a message that includes an OTP. In some examples, the secure resource access application can send idle messages over the public network at random or periodic intervals. In some examples, the idle message includes an identifier of the secure resource access application or the client device 120. In response to receiving the idle message, the authentication device 110 can extend an expiration time or validity period of any OTP that is associated with the identifier of the secure resource access application or client device 120. In some examples, the idle message includes a random token generated by the authentication device 110 at the same time as the OTP is generated. This token is transmitted to the client device 120 at the same time as the OTP is transmitted and the token is associated with the OTP in the authentication device 110. In this implementation, the client device 120 uses the token it received from the authentication device 110 (during the setup phase) in the idle message the client device 120 transmits to the authentication device 110 to extend an expiration time or validity period of any OTP that is associated with the token at the authentication device 110.

The secure resource access application can receive a user request to access the secure asset or PACS. In response, the secure resource access application determines whether an OTP for the selected secure asset has previously been received from the authentication device 110. If so, the secure resource access application transmits the OTP to the authentication device 110 over the public network (e.g., the unsecure BLE network) by sending a message that includes the OTP. The authentication device 110 receives the message and determines whether the received OTP corresponds to a valid OTP stored in the memory. If so, the authentication device 110 instructs the secure resource or the PACS to grant access and, in some cases, transmits a message to the secure resource access application indicating that access has been granted. If the OTP fails to correspond to a valid OTP or matches an OTP that is invalid, the authentication device 110 may, in some cases, transmit a message indicating that access has been denied. In such cases, the authentication device 110 can enable the client device 120 to perform authentication using another authentication process that is performed over a secure or unsecure channel.

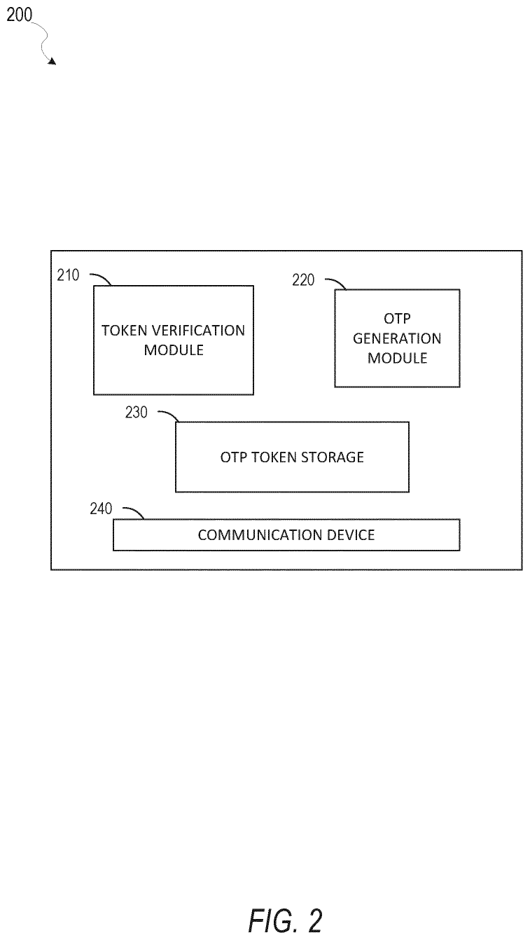

FIG. 2 is a block diagram of an example authentication device 200, according to some embodiments. The authentication device 200 can include some or all of the same features as the authentication device 110. The authentication device 200 includes a token verification module 210, an OTP generation module 220, an OTP token storage 230, and a communication device 240. The components illustrated in FIG. 2 can be implemented by the same device or can be distributed across multiple devices, such that some of the components are implemented by the authentication device 200 and others are implemented on the authentication server 140.

The communication device 240 can continuously or periodically monitor traffic on an open or public network or channel. In response to detecting an announce message on the open or public network or channel from a client device 120, the communication device 240 transmits an announce message back to the client device 120 with an identifier of one or more secure resources or assets protected by the authentication device 200. The client device 120, in response to receiving the announce message, automatically establishes a secure channel with the communication device 240. At this point, the communication device 240 transitions to communicating with the client device 120 over an encrypted secure channel, such as an encrypted BLE channel. In some cases, in response to the client device 120 receiving the announce message, the client device 120 can verify certain other conditions before automatically establishing the secure channel. For example, the client device 120 can access and verify certain access conditions, such as environment conditions, chronological conditions, preferential conditions, proximity to the authentication device 110, time of day, whitelist/blacklist of authentication devices 110. In this way, the client device 120 can discriminately automatically connect to certain authentication devices 110 to save power and avoid battery drain on the client device 120.

The client device 120 transmits a message which may include a token and/or device identifier with one or more credentials to the communication device 240 of the authentication device 200. The communication device 240 provides the received credentials and/or message to the token verification module 210. The token verification module 210 determines whether the received message and/or device identifier with one or more credentials is valid or authenticated for accessing any of the secure resources or assets protected by the authentication device 200. For example, the token verification module 210 accesses a list of authorized users or device identifiers and verifies whether the device identifier and/or credentials received over the secure channel matches any of the previously stored contents on the list. In response to determining that the device identifier and/or credentials is authorized for accessing one or more of the secure resources or assets protected by the authentication device 200, the token verification module 210 communicates with the OTP generation module 220 an identity of the client device 120 and the one or more of the secure resources or assets protected by the authentication device 200 that the device identifier and/or credentials is authorized to access. In some examples, in response to determining that the received device identifier and/or credentials is invalid, the authentication device 200 generates a dummy OTP and transmits the dummy OTP back to the client device 120. The dummy OTP cannot be used to access any secure or protected asset or resource. The transmission of the dummy OTP makes it difficult for an adversary to determine the access rights of a client device 120 via analysis of the connection duration, such as a timing attack. In some cases, the dummy OTP can be in a predefined format to make it possible for the secure resource access application to determine that access was not granted.

The OTP generation module 220 generates an OTP (e.g., a set of random numbers) independently of any information that identifies the client device 120. In some cases, the OTP is generated by applying a function to the message received from the client device 120 and/or the one or more of the secure resources or assets protected by the authentication device 200. The OTP generation module 220 provides the generated OTP to the OTP token storage 230. The OTP token storage 230 adds the OTP to a list of active and valid tokens along with an identifier of the client device 120. The OTP token storage 230, in some optional cases, also stores an associated expiration time or validity period with the OTP that is added. The OTP token storage 230 provides the generated token to the communication device 240 which transmits the generated OTP back to the client device 120 over the secure channel. The communication device 240 (and/or client device 120) then closes the secure channel and terminates the connection with the client device 120 (and/or communication device 240). In some cases, the OTP generation module 220 generates a random token that is used by the client device 120 in idle messages to extend validity of an OTP. In such cases, the communication device 240 transmits both the OTP and the random token. The OTP token storage 230 associates the random token with the generated OTP.

The client device 120 receives the OTP and locally stores the OTP in a memory in association with an identifier of the protected resource or asset associated with the OTP. In some cases, the client device 120 receives the OTP and locally stores the OTP in a memory in association with the identity of the authentication device 110 (e.g., a MAC address, IP address, and so forth). The client device 120 can also receive a randomly generated token to be transmitted as part of an idle message. In such cases, the client device 120 can continuously or periodically transmit idle messages that identify the client device 120 to the communication device 240 and/or idle messages that only include the randomly generated token. The idle messages can be transmitted over an open and unsecure channel, such as an unencrypted BLE channel. In some cases, the communication device 240 provides the identifier of the client device 120 to the OTP token storage 230. In some cases, the communication device 240 provides the received token to the OTP token storage 230. The OTP token storage 230 searches a list of previously stored OTPs to determine whether any of the OTPs is associated with the identifier of the client device 120 and/or the received token. In response to identifying a particular OTP associated with the identifier of the client device 120 received in the idle message and/or the received token in the idle message, the OTP token storage 230 may extend the expiration time by a threshold or specified amount to keep the OTP valid and active.

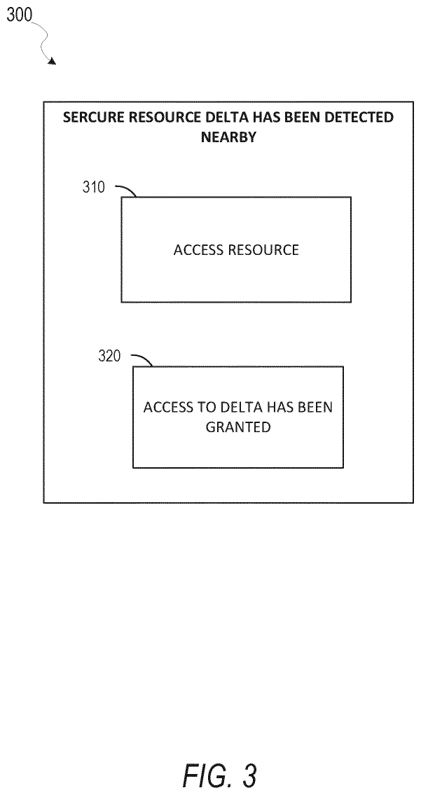

In some examples, the client device 120 can present a user interface, such as the user interface 300 shown in FIG. 3. The user interface 300 includes a message that informs the user about the identity of a nearby authentication device 200 and/or secure asset or protected resource that is within a communication distance to the client device 120. The user interface 300 includes an option 310 to access the identified resource. In response to receiving a user input that selects the option 310 to access the identified resource, the client device 120 retrieves the OTP from the memory associated with the identified resource. The client device 120 transmits a message that includes the OTP over an unsecure, public, and open channel for receipt by the communication device 240. The communication device 240 can receive the message with the OTP from the client device 120 over the public network, such as the public BLE network. The communication device 240 extracts the OTP from the message and provides the OTP to the OTP token storage 230.

In some cases, rather than waiting for the user input to transmit the OTP to the authentication device 110, the client device 120 can determine that the client device 120 is within a second threshold proximity to the authentication device 110. In response, the client device 120 can automatically transmit the OTP over the unsecure channel. Namely, a first threshold proximity between the client device 120 and the authentication device 110 can be used to establish a secure channel automatically to generate and exchange the OTP token. A second threshold proximity which is smaller or closer than the first threshold proximity can be used to trigger an exchange of the OTP token over an unsecure channel back to the authentication device 110 to obtain access to the protected asset. There may exist other triggers or conditions for automatically transmitting the OTP over the unsecure channel, such as motion gestures with the client device 120, reading an NFC tag, and so forth.

The OTP token storage 230 searches a list of previously stored OTPs to determine whether any of the OTPs matches the OTP extracted from the message received from the client device 120 over the public unsecure channel. In response to identifying a particular OTP that matches or corresponds to the extracted OTP, the OTP token storage 230 determines whether the status of the OTP is valid (e.g., whether the expiration time has elapsed or whether the OTP has been used before). In response to determining that the OTP is valid (e.g., the expiration time has not elapsed and/or the OTP has not been previously used to access a protected resource), the OTP token storage 230 communicates an instruction to the token verification module 210 to grant access to the secure resource or PACS. The OTP token storage 230 also updates a status of the OTP to be invalid to prevent re-use of the OTP for accessing the protected resource. Alternatively, the OTP token storage 230 deletes the OTP stored in association with the device identifier and/or random token. The OTP token storage 230 also, in some optional cases, instructs the communication device 240 to send a message to the client device 120 indicating that access has been granted. The client device 120 presents the message 320 in the user interface 300 informing the user that the access to the protected resource has been granted. In some cases, the OTP token storage 230 determines one or more additional conditions for granting access based on a valid OTP, such as environment conditions including transmission power of the message containing the OTP, proximity of the client device 120, and so forth.

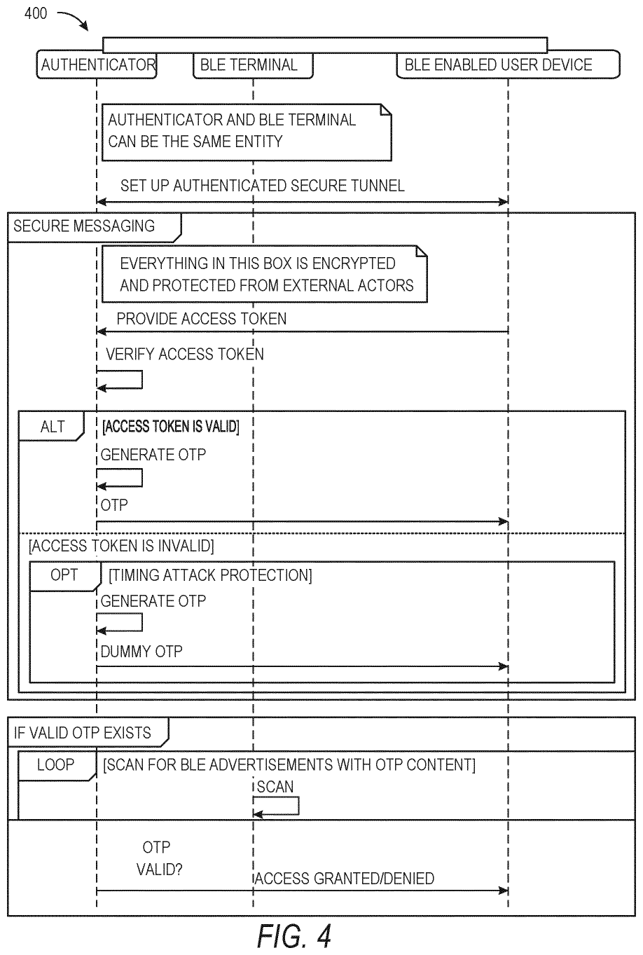

FIG. 4 illustrates example operations of the authentication system 100, according to some embodiments. Specifically, FIG. 4 shows a sequence of operations 400 performed to exchange an OTP over a secure channel automatically (before receiving a user request to access a secure resource) with the client device 120. The sequence of operations 400 include the operations performed for receiving an OTP from a client device 120 over an unsecure channel to grant/deny access to a protected resource or asset. The authenticator shown in FIG. 4 can include the authentication device 110, the BLE terminal shown in FIG. 4 can include a protected resource, such as PACS, protected by the authentication device 110, and the BLE enabled user device can include the client device 120.

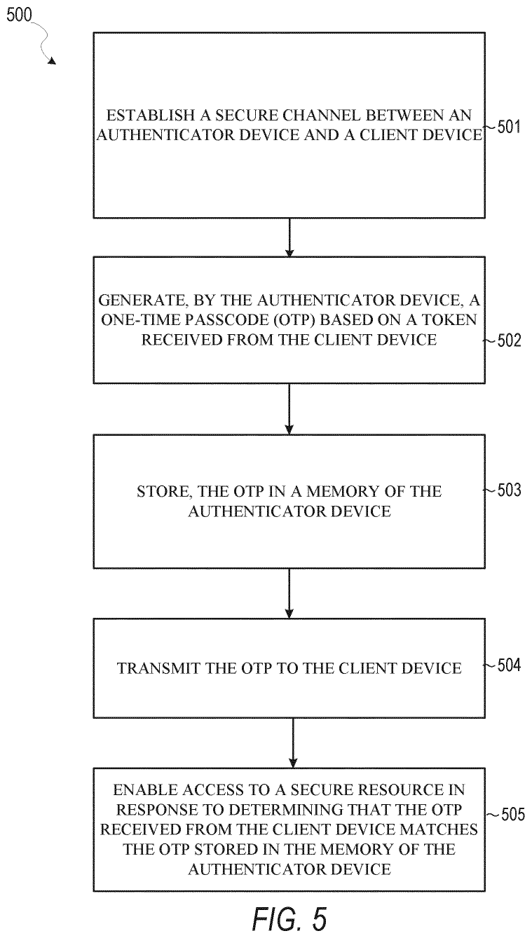

FIG. 5 is a flowchart illustrating example process 500 of the authentication system 100, according to example embodiments. The process 500 may be embodied in computer-readable instructions for execution by one or more processors such that the operations of the process 500 may be performed in part or in whole by the functional components of the authentication system 100; accordingly, the process 500 is described below by way of example with reference thereto. However, in other embodiments, at least some of the operations of the process 500 may be deployed on various other hardware configurations. Some or all of the operations of process 500 can be in parallel, out of order, or entirely omitted.

At operation 501, the authentication system 100 establishes a secure channel between an authenticator device and a client device, as discussed above.

At operation 502, the authentication system 100 generates, by the authenticator device, a one-time passcode (OTP) based on a token received from the client device, as discussed above.

At operation 503, the authentication system 100 stores the OTP in a memory of the authenticator device, as discussed above.

At operation 504, the authentication system 100 transmits the OTP to the client device, as discussed above.

At operation 505, the authentication system 100 enables access to a secure resource in response to determining that the OTP received from the client device matches the OTP stored in the memory of the authenticator device, as discussed above.

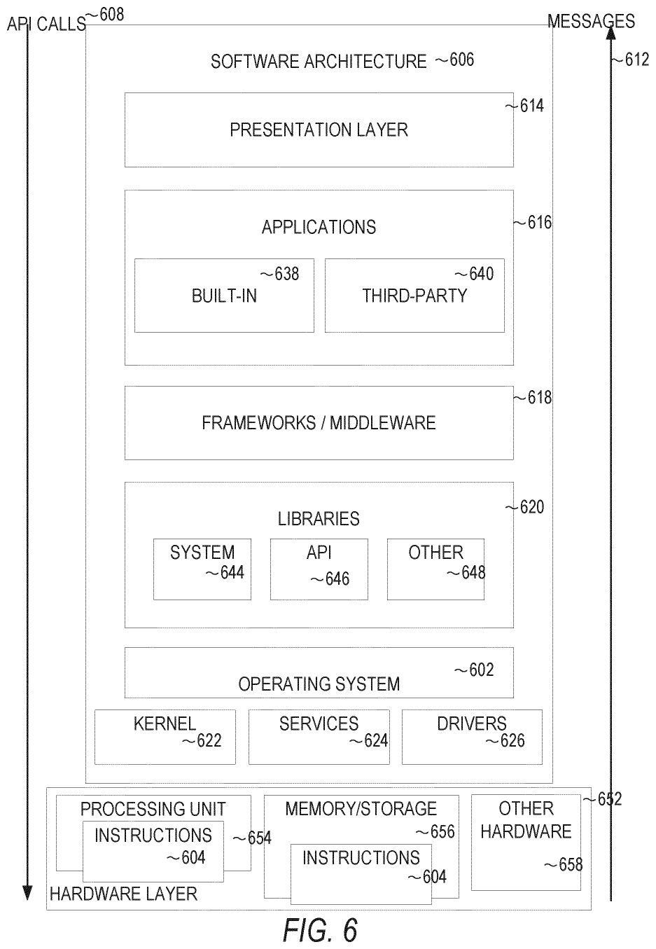

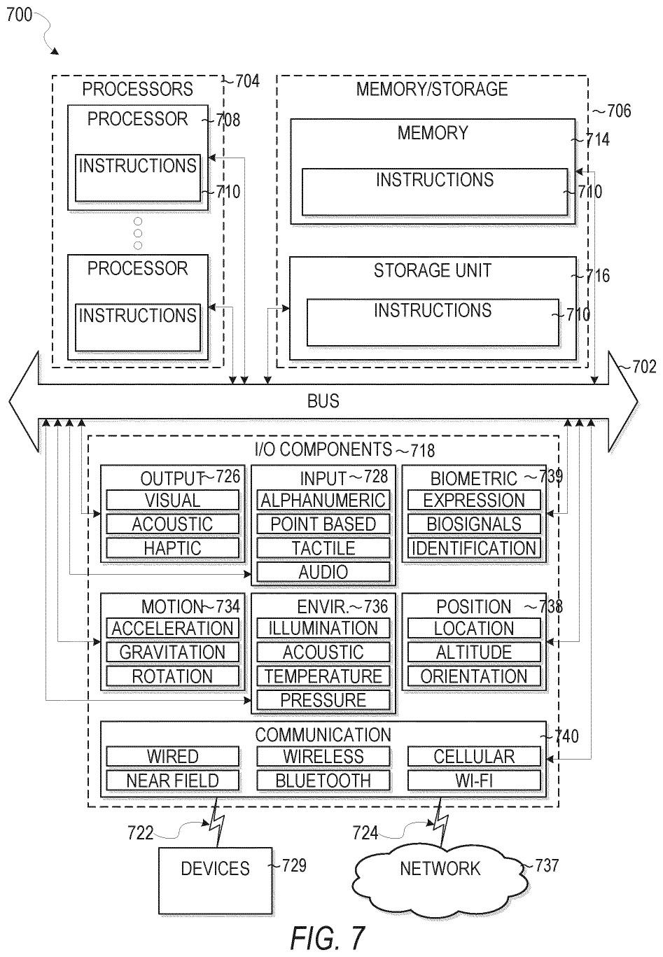

FIG. 6 is a block diagram illustrating an example software architecture 606, which may be used in conjunction with various hardware architectures herein described. FIG. 6 is a non-limiting example of a software architecture and it will be appreciated that many other architectures may be implemented to facilitate the functionality described herein. The software architecture 606 may execute on hardware such as machine 700 of FIG. 7 that includes, among other things, processors 704, memory 714, and input/output (I/O) components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage devices memory/storage 656, which also have executable instructions 604. The hardware layer 652 may also comprise other hardware 658. The software architecture 606 may be deployed in any one or more of the components shown in FIG. 1.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke API calls 608 through the software stack and receive messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, BLE drivers, UWB drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624 and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPREG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/devices.

The frameworks/middleware 618 (also sometimes referred to as middleware) provide a higher-level common infrastructure that may be used by the applications 616 and/or other software components/devices. For example, the frameworks/middleware 618 may provide various graphic user interface functions, high-level resource management, high-level location services, and so forth. The frameworks/middleware 618 may provide a broad spectrum of other APIs that may be utilized by the applications 616 and/or other software components/devices, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built-in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed.

As such, the instructions 710 may be used to implement devices or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. In an example embodiment, the processors 704 (e.g., a CPU, a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 708 that may execute the instructions 710. The term “processor” is intended to include multi-core processors 704 that may comprise two or more independent processors (sometimes referred to as “cores”) that may execute instructions contemporaneously. Although FIG. 7 shows multiple processors 704, the machine 700 may include a single processor with a single core, a single processor with multiple cores (e.g., a multi-core processor), multiple processors with a single core, multiple processors with multiple cores, or any combination thereof.

The memory/storage 706 may include a memory 714, such as a main memory, or other memory storage, instructions 710, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a LED display, a LCD, a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 739, motion components 734, environmental components 736, or position components 738 among a wide array of other components. For example, the biometric components 739 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 737 or devices 729 via coupling 724 and coupling 722, respectively. For example, the communication components 740 may include a network interface component or other suitable device to interface with the network 737. In further examples, communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 729 may be another machine or any of a wide variety of peripheral devices (e.g., a peripheral device coupled via a USB).

Moreover, the communication components 740 may detect identifiers or include components operable to detect identifiers. For example, the communication components 740 may include RFID tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geo-location, location via Wi-Fi® signal triangulation, location via detecting an NFC beacon signal that may indicate a particular location, and so forth.

### Glossary:

“CARRIER SIGNAL” in this context refers to any intangible medium that is capable of storing, encoding, or carrying transitory or non-transitory instructions for execution by the machine, and includes digital or analog communications signals or other intangible medium to facilitate communication of such instructions. Instructions may be transmitted or received over the network using a transitory or non-transitory transmission medium via a network interface device and using any one of a number of well-known transfer protocols.

“COMMUNICATIONS NETWORK” in this context refers to one or more portions of a network that may be an ad hoc network, an intranet, an extranet, a VPN, a LAN, a BLE network, a UWB network, a WLAN, a WAN, a WWAN, a metropolitan area network (MAN), the Internet, a portion of the Internet, a portion of the PSTN, a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device, or other tangible media able to store instructions and data temporarily or permanently and may include, but is not limited to, RAM, ROM, buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a FPGA or an ASIC. A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a CPU, a RISC processor, a CISC processor, a GPU, a DSP, an ASIC, a RFIC, or any combination thereof. A processor may further be a multi-core processor having two or more independent processors (sometimes referred to as “cores”) that may execute instructions contemporaneously.

Changes and modifications may be made to the disclosed embodiments without departing from the scope of the present disclosure. These and other changes or modifications are intended to be included within the scope of the present disclosure, as expressed in the following claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A method comprising:
establishing a secure channel between an authenticator device and a client device;
generating, by the authenticator device, a one-time passcode (OTP) based on a token received from the client device;
storing the OTP in a memory of the authenticator device;
transmitting the OTP to the client device over the secure channel;
receiving the OTP from the client device over an unsecure channel; and
enabling access to a secure resource in response to determining that the OTP received from the client device matches the OTP stored in the memory of the authenticator device.

2. The method of claim 1, further comprising:
verifying that the token received from the client device is valid, wherein the OTP is generated in response to determining that the token is valid.

3. The method of claim 1, further comprising:
determining, by the authenticator device, whether one or more valid OTPs are stored in the memory; and
in response to determining that one or more valid OTPs are stored in the memory of the authenticator device, initiating scanning an unsecure channel for an OTP message.

4. The method of claim 3, wherein the OTP received from the client device is included in the OTP message.

5. The method of claim 1, wherein the secure channel comprises a secure short-range communications channel, and wherein the unsecure channel comprises a public short-range communications channel.

6. The method of claim 1, wherein the secure channel comprises a first protocol, and wherein the unsecure channel comprises a second protocol.

7. The method of claim 1, wherein the secure channel is established automatically in response to detecting a signal from the client device and verification of one or more access conditions.

8. The method of claim 1, wherein the OTP is transmitted by the client device over the unsecure channel in response to receiving a user request by the client device to access the secure resource, further comprising:
transmitting a message to client device indicating that the access to the secure resource has been enabled.

9. The method of claim 1, further comprising:
associating an expiration time with the OTP that is stored in the memory; and
invalidating or removing the OTP after the expiration time.

10. The method of claim 9, wherein the OTP is received from the client device after the expiration time, further comprising:
preventing access to the secure resource; and
transmitting a message to client device indicating that the access to the secure resource has been prevented.

11. The method of claim 9, further comprising:
receiving, by the authenticator device, an idle token from the client device; and
in response to receiving the idle token, extending the expiration time associated with the OTP.

12. The method of claim 11, wherein the idle token is received over the unsecure channel.

13. The method of claim 1, further comprising:
invalidating the OTP after receiving the OTP from the client device over the unsecure channel, wherein access to the secure resource is prevented in response to receiving an invalid OTP.

14. The method of claim 13, further comprising:
after invaliding the OTP, receiving the OTP from the same or another client device;
determining that the OTP has been invalidated; and
preventing access to the secure resource in response to determining that the OTP has been invalidated.

15. The method of claim 1, wherein the authenticator device comprises a server, wherein the server transmits an instruction to a physical access control device to enable access to the secure resource.

16. The method of claim 1, wherein the authenticator device comprises a physical access control device to enable access to the secure resource.

17. The method of claim 1, wherein the OTP is generated prior to the client device receiving a request to access the secure resource.

18. A system comprising:
one or more processors configured to perform operations comprising:
establishing a secure channel between an authenticator device and a client device;
generating, by the authenticator device, a one-time passcode (OTP) based on a token received from the client device;
storing, the OTP in a memory of the authenticator device;
transmitting the OTP to the client device over the secure channel;
receiving the OTP from the client device over an unsecure channel; and
enabling access to a secure resource in response to determining that the OTP received from the client device matches the OTP stored in the memory of the authenticator device.

19. The system of claim 18, the operations further comprising:
verifying that the token received from the client device is valid, wherein the OTP is generated in response to determining that the token is valid.

20. A non-transitory computer-readable medium comprising non-transitory computer-readable instructions that, when executed by one or more processors, configure the one or more processors to perform operations comprising:
establishing a secure channel between an authenticator device and a client device;
generating, by the authenticator device, a one-time passcode (OTP) based on a token received from the client device;
storing, the OTP in a memory of the authenticator device;
transmitting the OTP to the client device over the secure channel;
receiving the OTP from the client device over an unsecure channel; and
enabling access to a secure resource in response to determining that the OTP received from the client device matches the OTP stored in the memory of the authenticator device.
